(19) United States
(12) Patent Application Publication
(10) Pub. No.: US 2021/0064905 A1
(43) Pub. Date: Mar. 4, 2021

(54) CONTENT INTEGRITY OF ANIMATIONS

(71) Applicant: QUALCOMM Incorporated, San Diego, CA (US)

(72) Inventors: Rahul GULATI, San Diego, CA (US); Robert HARDACKER, Fallbrook, CA (US); Sumant PARANJPE, San Diego, CA (US); Reza KAKOEE, San Diego, CA (US); John Chi Kit WONG, Aurora (CA); Sanjay GUPTA, North York (CA); Alex JONG, San Diego, CA (US)

(21) Appl. No.: 16/554,735

(22) Filed: Aug. 29, 2019

(51) Int. Cl. G06K 9/32; G06T 13/20; G08B 6/00; G06F 3/01; G06F 3/0481

(52) U.S. Cl. CPC G06K 9/3241; G06K 9/325; G06F 3/04817; G08B 6/00; G06F 3/016; G06T 13/20

(57) ABSTRACT

Certain aspects of the present disclosure generally relate to testing functionality of the display system. An example method generally includes selecting a first data integrity check value, associated with a region of interest (ROI) of an input frame, among a set of data integrity check values stored on a memory device, the data integrity check values are associated with an animation comprising a plurality of frames, and at least one of the frames of the animation corresponds to the input frame; processing, with a display processor, the input frame; calculating a second data integrity check value on the ROI of the input frame after the display processor processes the input frame; comparing, with a comparator, the data integrity check values; and generating, with the comparator, an interrupt if the comparison indicates that the values do not match.

### BACKGROUND

### Field of the Disclosure

Certain aspects of the present disclosure generally relate to a system-on-chip (SoC) and, more particularly, to testing functionality of a display system of a SoC for content integrity.

### Description of Related Art

A modern automobile is a powerful and complex electro-mechanical system that includes a large number of processors, sensors, and systems-on-chips (SoCs) that control many of the vehicle's functions, features, and operations. More recently, manufacturers have begun equipping automobiles with Advanced Driver Assistance Systems (ADASs) that automate, adapt, or enhance the vehicle's operations. For example, an ADAS may be configured to use information collected from the automobile's sensors (e.g., accelerometer, radar, lidar, geospatial positioning, etc.) to automatically detect a potential road hazard, and assume control over all or a portion of the vehicle's operations (e.g., braking, steering, etc.) to avoid detected hazards. Features and functions commonly associated with an ADAS include adaptive cruise control, automated lane detection, lane departure warning, automated steering, automated braking, and automated accident avoidance.

A safety critical ADAS may be required to fulfill functional safety requirements, such as those mandated by ISO 26262 (functional safety standard for road vehicles). One functional safety requirement is to ensure data content integrity for one or more areas of image data sent to a display. A failure to display correct image data may lead to a violation of defined safety goals for an automotive application. Example automotive applications that may use displays include a rear view camera system, front collision warning systems, traffic sign recognition systems, parking assistance systems, instrument cluster displays providing so-called “tell-tale” sign information, etc.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include an improved content integrity of a display system such as for safety critical applications.

Certain aspects of the present disclosure provide a method of testing a display system. The method generally includes selecting a first data integrity check value, associated with a region of interest (ROI) of an input frame, among a set of data integrity check values stored on a memory device, wherein the data integrity check values are associated with an animation comprising a plurality of frames, and at least one of the frames of the animation corresponds to the input frame. The method also includes processing, with a display processor, the input frame and calculating a second data integrity check value on the ROI of the input frame after the display processor processes the input frame. The method further includes comparing, with a comparator, the first data integrity check value to the second data integrity check value and generating, with a comparator, an interrupt if the comparison indicates that the first data integrity check value and the second data integrity check value do not match. The method also includes outputting, with the display processor, the input frame to a display device.

Certain aspects of the present disclosure provide an apparatus. The apparatus generally includes a memory device having a set of data integrity check values stored thereon. The apparatus also includes a processor configured to process an input frame, output the input frame to a display device, select a first data integrity check value, associated with a region of interest (ROI) of the input frame, among the set of data integrity check values stored on the memory device, wherein the data integrity check values are associated with an animation comprising a plurality of frames, and at least one of the frames of the animation corresponds to the input frame, and calculate a second data integrity check value on the ROI of the input frame after the display processor processes the input frame. The apparatus further includes a comparator configured to compare the first data integrity check value to the second data integrity check value and generate an interrupt if the comparison indicates that the first data integrity check value and the second data integrity check value do not match.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of example components and interconnections in a system-on-chip (SoC), in accordance with certain aspects of the present disclosure.

FIG. 2 illustrates a sequence of frames with an example animation, in accordance with certain aspects of the present disclosure.

FIG. 3 is a block diagram illustrating an example display system, in accordance with certain aspects of the present disclosure.

FIG. 4 is a block diagram illustrating example hardware aspects of the display system of FIG. 3, in accordance with certain aspects of the present disclosure.

FIG. 5 is a diagram illustrating example animated graphics grouped into regions-of-interest, in accordance with certain aspects of the present disclosure.

FIG. 6 is a flow diagram of example operations for performing content integrity of an animation, in accordance with certain aspects of the present disclosure.

### DETAILED DESCRIPTION

Aspects of the present disclosure generally relate to ensuring a display system does not malfunction, such as while operating in safety critical applications, such as during displaying information on the various screens of a vehicle. For example, certain aspects of the present disclosure provide techniques for monitoring and testing a display system of a SoC, such as ensuring that animated warnings for safety critical use cases are displayed as expected. The animated warnings may be for a vehicle (e.g., automotive vehicle) and may correspond to animated warnings from an instrument cluster, rear view camera application, ADAS application, etc. of the vehicle.

To ensure that the display system is operating correctly without fault, a display system may perform testing related to the integrity of the content to be displayed to detect operational faults that may occur while the display system processes the content for display by a display device. The aspects of the present disclosure specifically relate to concurrent and/or online testing of content integrity of an animation for display. In this context, testing of content integrity of an animation may include testing that confirms that the content that is going to be displayed is the same as the content that was expected to be displayed. Concurrent testing of the display system may be a continuous testing of the display system while the computing device is operating. Online testing of the display system may include testing of the display system while the computing device and the system are powered on and performing its normal functionality, such as operating while deployed to an end-user. In other words, a computing device may perform testing of the display system while the computing device is powered on and in use by a user without entering into a dedicated test mode, and without switching off the display device. Thus, if the computing device is an ADAS, the user of the ADAS may use the ADAS to, for example, view video streamed from a rear view camera to a rear view camera display and/or view warning or tell-tale icons in an instrument cluster while the ADAS performs concurrent and online testing of the display system.

Such concurrent and online testing of the display system may detect operational faults of the display system, which may include a blank screen, a frozen frame, or an incorrect display of image content (such as selecting an incorrect image when multiple images are available). The display system may receive video data from multiple sources such as a driver monitoring camera and a vehicle reverse camera. When a vehicle is placed in reverse, it may be expected that the display system selects the image from the reverse camera, not the driver monitoring camera. Operational faults may include permanent faults, intermittent faults, and transient faults. Permanent faults may be faults that remain in existence indefinitely if no corrective action is taken. Such faults may be residual design or manufacturing faults. Intermittent faults may appear, disappear, and reappear repeatedly. Such faults may be difficult to predict but their effects may be highly correlated. When such intermittent faults appear, the display system may work correctly most of the time but may fail under atypical environmental conditions. Transient faults may appear and disappear quickly, and such faults may not be correlated. Such transient faults are often induced by random environmental disturbances.

A computing system (e.g., a SoC) may perform concurrent and online testing of display content integrity in order to detect faults of the display system. This disclosure describes techniques for ensuring data content integrity in display sub-systems. The techniques of this disclosure may have application in automotive display systems, avionics display systems, or any other display system where it may be beneficial to ensure that the image data intended to be displayed is actually displayed.

In some example display systems, a data integrity check value may be generated for an entire input frame or a region-of-interest of the input frame. Such a data integrity check value may be any type of value generated to check the validity of raw or processed data (e.g., image data). A data integrity check value may be any type of value that may be generated by performing an operation on data before processing (e.g., a region-of-interest of image data). Another data integrity check value may be performed on the same data after some processing, transmission, memory storage, etc. The two generated data integrity check values may then be compared to determine whether or not the data has changed. In some examples, such a data integrity check value is only generated prior to any display processing by a display processor.

Examples of data integrity check values may be values generated by a cyclic redundancy check (CRC) code, a hash function, checksums, a multiple input signature register (MISR) value or signature, or other values generated through other techniques. Display systems may use a MISR algorithm to implement a cyclic redundancy check to aid in verification of the integrity of the display. In some examples, data is collected for a programmable number of frames before updating the MISR. The register value can be compared to an expected value to validate if the display hardware is behaving properly.

As will be explained in more detail below, in examples of the present disclosure, the MISR hardware may be a standalone block that is instantiated at various points in a display processing pipeline. In some examples, a display system may include a MISR block for each display peripheral output that can collect a MISR signature on the final composed image being sent to the display peripheral. In some examples, each display MISR block can run concurrently and independently.

A CRC code is an error-detecting code that is often used to detect changes in data. CRCs are generated using cycle codes that produce a value that maps data of an arbitrary size to data of a fixed size. Hash functions are sometimes used in a hash table for accelerated lookup of duplicated records. Hash functions may also be used to generate data integrity check values for image data before and after processing. A checksum is data produced by an algorithm operating on data (e.g., image data) in order to detect errors during transmission, processing, or storage.

To ensure the integrity of image data after being processed by a display processor or other processing circuit, this disclosure proposes calculating a data integrity check value (e.g., a CRC, MISR, checksum, etc.) based on a software model of the processing to be performed by such a display processor or processing circuit. For example, one or more user-configurable regions-of-interest (ROI) of input image data (e.g., safety critical image data) may be processed by the software model and a data integrity check value (e.g., an Input MISR) associated with an animation, as further described herein, may be calculated on the output ROI of the software model. The image data may then be processed by the display processor for eventual display. After processing by the display processor, another data integrity check value (e.g., an Output MISR) may be generated for the ROI of the image to be displayed (i.e., the output image). The Input MISR and the Output MISR may be supplied to a comparator circuit. If the Input MISR and Output MISR match (e.g., within some margin for error, such as a threshold), the output image is determined to be correct and is displayed. If the Input MISR and Output MISR do not match (e.g., are outside some margin for error), an interrupt is generated and an alert and/or recovery process may be initiated.

### Example System-On-Chip

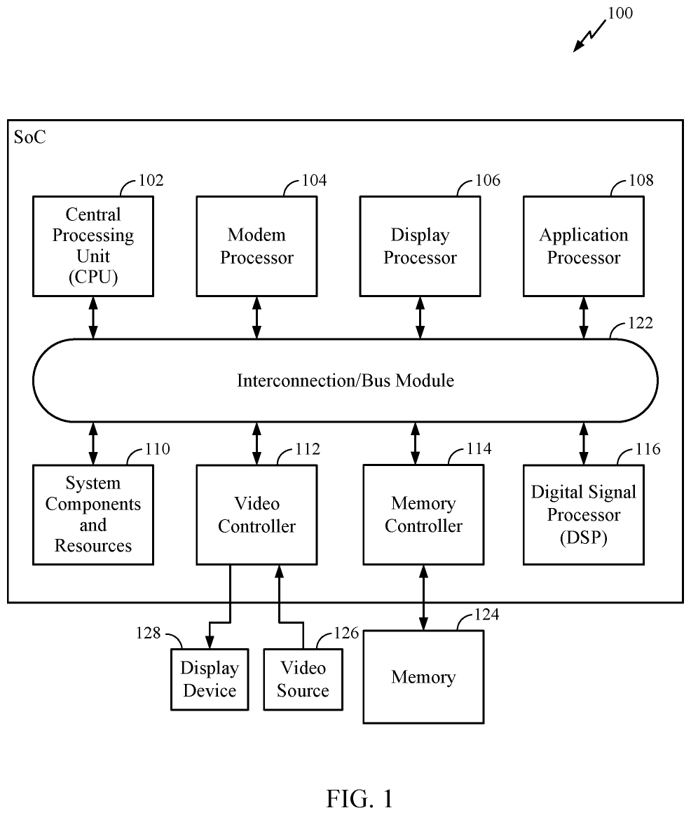

FIG. 1 is a block diagram of example components and interconnections in a system-on-chip (SoC) 100 suitable for implementing various aspects of the present disclosure. The SoC 100 may include a number of heterogeneous processors, such as a central processing unit (CPU) 102, a modem processor 104, a display processor 106 (e.g., a graphics processing unit (GPU) or graphics processor), an application processor 108, and a digital signal processor 116. Each processor 102, 104, 106, 108, 116, may include one or more cores, and each processor/core may perform operations independent of the other processors/cores. Each processor 102, 104, 106, 108, 116 may be part of a subsystem (not shown) including one or more processors, caches, etc. configured to handle certain types of tasks or computations. It should be noted that SoC 100 may include additional processors (not shown) or may include fewer processors (not shown).

The SoC 100 may include system components and resources 110 for managing sensor data, analog-to-digital conversions, wireless data transmissions, and for performing other specialized operations (e.g., decoding high-definition video, video processing, etc.). System components and resources 110 may also include components such as voltage regulators, oscillators, phase-locked loops, peripheral bridges, data controllers, system controllers, access ports, timers, and other similar components used to support the processors and software clients running on the computing device. The system components and resources 110 may also include circuitry for interfacing with peripheral devices, such as cameras, electronic displays, wireless communication devices, external memory chips, etc.

The SoC 100 may further include system components and resources 110, a video controller 112, one or more memory controllers 114 (e.g., a dynamic random access memory (DRAM) memory controller). The SoC 100 may also include an input/output (IO) module (not shown) for communicating with resources external to the SoC, such as a clock and a voltage regulator, each of which may be shared by two or more of the internal SoC components.

The processors 102, 104, 106, 108, 116 may be interconnected to system components and resources 110, video controller 112, the memory controller 114, and other system components via an interconnection/bus module 122, which may include an array of reconfigurable logic gates and/or implement a bus architecture (e.g., CoreConnect, AMBA, etc.). Communications may also be provided by advanced interconnects, such as high performance networks-on chip (NoCs).

The interconnection/bus module 122 may include or provide a bus mastering system configured to grant SoC components (e.g., processors, peripherals, etc.) exclusive control of the bus (e.g., to transfer data) for a set duration, number of operations, number of bytes, etc. In an aspect, the bus module 122 may include a direct memory access (DMA) controller (not shown) that enables components connected to the bus module 122 to operate as a master component and initiate memory transactions. The bus module 122 may also implement an arbitration scheme to prevent multiple master components from attempting to drive the bus simultaneously.

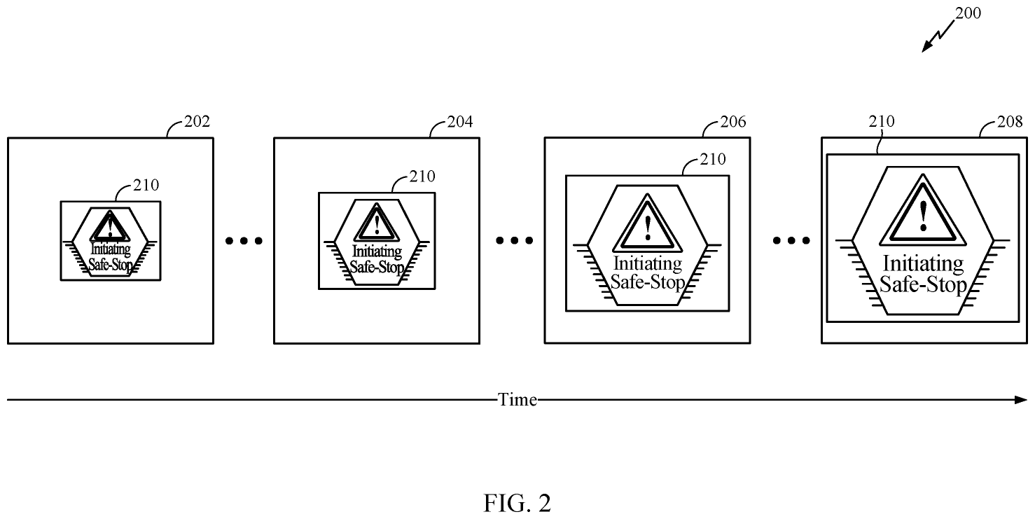

The video controller 112 may manage the flow of video input feeds and/or video output feeds to or from the display processor 106. The video controller 112 may be a video display controller that receives a video signal from a video source 126 and/or sends a video signal to a display device 128. For example, the video controller 112 may be coupled to the video source 126 (such as one or more video cameras and/or sensors) that generates video frames for further processing by the display processor 106 as further described herein with respect to FIGS. 2-6. The video controller 112 may also be coupled to the display device 128, such as a digital instrument cluster, heads-up display (HUD), center-console display, a display embedded or integrated in a rear view mirror, or any suitable display, that receives video frames output by the display processor 106 as further described herein with respect to FIGS. 2-6. In certain aspects, the video controller 112 may be integrated with the display processor 106.

The memory controller 114 may be a specialized hardware module configured to manage the flow of data to and from a memory 124. The memory controller 114 may include logic for interfacing with the memory 124, such as selecting a row and column in a cell array of the memory 124 corresponding to a memory location, reading or writing data to the memory location, etc. The memory 124 may be an on-chip component (e.g., on the substrate, die, integrated chip, etc.) of the SoC 100, or alternatively (as shown) an off-chip component.

### Example Content Integrity of Animations

Aspects of the present disclosure describe techniques and systems for performing content integrity checks of animations output by a display system in safety critical applications, such as automotive display systems. For example, the techniques and systems, described herein, may ensure data content integrity of animations for safety critical displays such as an instrument cluster, heads-up display (HUD), or augmented display in a vehicle. The techniques and systems, described herein, may perform concurrent online integrity check calculations (e.g., a MISR, CRC, or checksum calculation) on an animation (e.g., an animated graphic or icon) in safety critical automotive displays. The integrity checks described herein may allow vehicle manufacturers to support driving modes with specific animated graphics for an automotive display device (such as an instrument cluster or HUD) while maintaining functional safety requirements for the displays.

FIG. 2 is a diagram illustrating an example animation 200, in accordance with certain aspects of the present disclosure. As shown, the animation 200 includes a set of frames 202, 204, 206, and 208 arranged in a sequence over time. Each of the frames 202, 204, 206, and 208 include an animated graphic 210 that changes in appearance over the course of the sequence of frames. In aspects, the sequence of frames may include other intermediate frames between the frames 202 and 204, between the frames 204 and 206, and/or between the frames 206 and 208. As an example, the intermediate frames between the frames 202 and 204 (or between the frames 204 and 206 and/or between the frames 206 and 208) may be identical in appearance to the previous frame (e.g., frame 202) to give the appearance that the animated graphic 210 remains unchanged for a temporary period of time. In other aspects, the intermediate frames may have a different appearance relative to the previous frames.

In aspects, the animated graphic 210 may be any suitable graphic including an icon, symbol, text, image, or tell-tale. The animated graphic 210 may change in size, color, position, and/or orientation over the course of the sequence of frames. In other aspects, the animated graphic 210 may transform into a different icon, graphic, symbol, and/or tell-tale within the sequence of frames. In general, a tell-tale may be any icon on a vehicle display that provides some information about the vehicle or the operating environment of the vehicle. Tell-tale icons may include warning symbols, a speedometer, a tachometer, a voltage gauge, a coolant temperature gauge, a boost gauge, a fuel gauge, warning lamps, and the like. The various changes of the animated graphic 210 over the course of the sequence of frames may be referred to herein as an animation or a three-dimensional (3D) graphic. The animation 200 may be, for example, an animation of a warning icon, graphic, symbol, or tell-tale used in safety critical automotive displays.

As an example, the animation 200 may be of an animated symbol or tell-tale associated with an autonomous vehicle operation such as adaptive cruise control, automated lane detection, lane departure warning, automated steering, automated braking, and/or automated accident avoidance. For example, suppose a driver has engaged adaptive cruise control or automated steering, which may require the driver to keep their hands on the steering wheel. If the vehicle detects that the driver's hands have been removed from the steering wheel, the vehicle display system may depict the animated graphic 210 in the color yellow to remind the driver to keep their hands on the steering wheel. If the vehicle continues to detect that the driver's hands are off the steering wheel, the vehicle display system may depict the animated graphic 210 in the color red to escalate the importance of the reminder.

As other examples, the animation 200 may depict the movement of a needle in a dial such as a speedometer or tachometer. For example, the animation 200 may depict the needle rising in the dial as the vehicle accelerates, or the animation 200 may depict the needle falling in the dial as the vehicle slows down. As another example, the animation 200 may be a rolling message, pop-up message, or any other animated message.

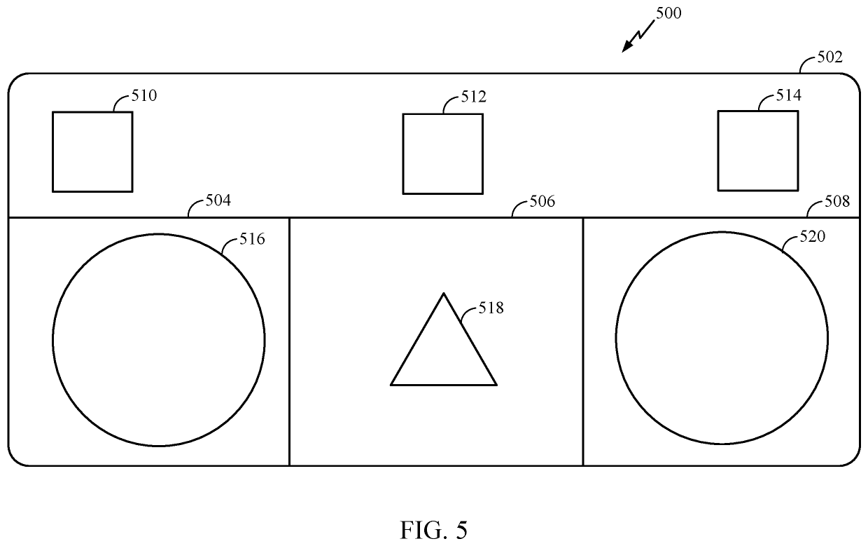

It should be appreciated that the frames 202, 204, 206, and 208 depicted in FIG. 2 may also represent segments of larger frames, such as regions-of-interest (ROIs). As will be discussed in more detail with respect to FIG. 5, the ROIs may be user-configurable and may indicate areas or segments of a frame to be displayed where it is preferable to verify the integrity of the frame displayed. For example, user-configurable ROIs may include animations (e.g., the animation 200) displayed in a digital instrument cluster, HUD, center-console display, or the like. According to certain aspects of the present disclosure, data integrity check values associated with one or more animations may be computed for each of a plurality of ROIs of an input frame, may be calculated on groups of ROIs, or may be calculated for an entire frame. The locations of the ROIs of frame to be processed by the display processor 106 may be stored in the memory 124. ROI configuration information may include indications of the locations of the ROIs of an input frame and may be accessed by the display processor 106.

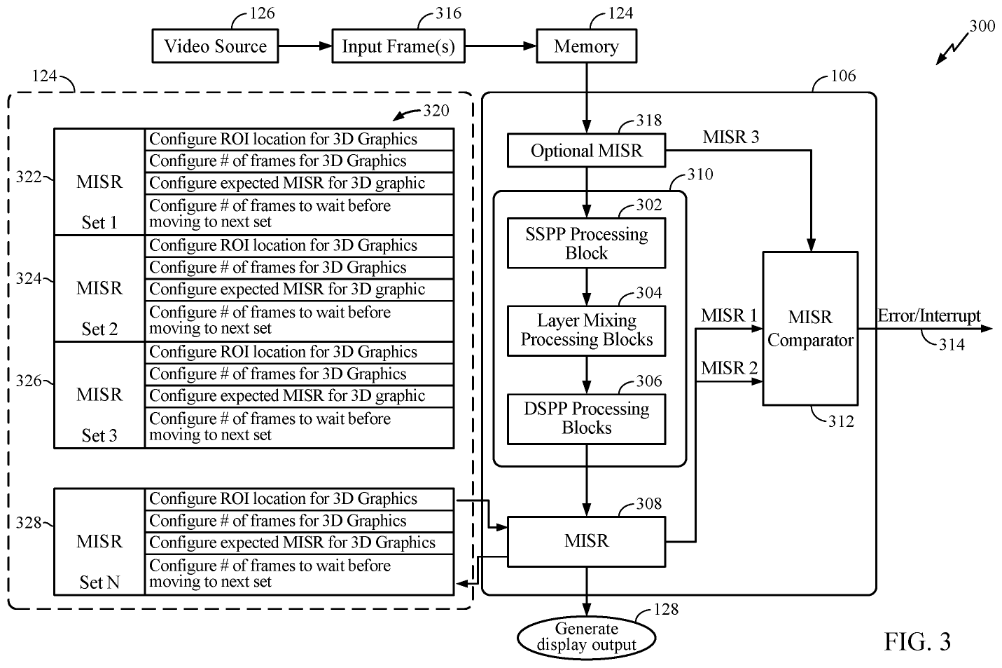

FIG. 3 is a block diagram illustrating an example display system 300, in accordance with certain aspects of the present disclosure. As shown, the display system 300 may include the display processor 106, the memory 124, the video source 126, and the display device 128. The display system 300 may be included in a SoC (e.g., the SoC 100).

The display processor 106 may include a processing pipeline 310, including, for example, a source surface processing pipeline (SSPP) 302, a layer mixing processing block 304, and a destination surface processing pipeline (DSPP) 306. The display processor 106 may also include a first data integrity calculation block 308, a comparator 312, and a second data integrity calculation block 318.

The display system 300 may perform concurrent online testing of the display processor 106 using the various techniques described herein to ensure the integrity of an animation appearing in video data. For example, the display system 300 may perform a built-in self-test of the display processor 106, by comparing data integrity check values 320 associated with an animation with values calculated by the first data integrity calculation block 308, while the display system 300 is operating, for example, as deployed to the end-user. As an example, the display system 300 may perform concurrent online testing of the display processor 106 while a video source 126 captures a real-time video frames and as the display system 300 outputs, via the display device 128, the processed input frame(s) 316.

Referring to FIG. 3, the display processor 106 may fetch an input frame 316 from the memory 124. In aspects, the input frame 316 may be stored in the memory 124 and/or generated by the video source 126 or display processor 106. The input frame 316 may include any frame generated via external sources (e.g. cameras or sensors) or internal content generators such a processor (e.g., processors 102 or 106). The input frame 316 may be a frame of a video from the video source 126 or any other image (e.g., tell-tale icons for an instrument cluster) that is to be processed by the display processor 106 for display by the display device 128. As an example, the input frame 316 may be generated by a rear camera of the vehicle to assist the driver in backing up the vehicle. In other examples, the input frame 316 may be an image generated from a navigation system to provide turn-by-turn navigation instructions on the instrument cluster or center-console display.

The processing pipeline 310 may provide processing blocks through which the input frames are processed for displaying to the display device 128. For example, the SSPP 302 may perform pre-mixer processing functions such as format conversion and quality improvement for source surfaces of the input frame. The SSPP 302 may process a received frame by performing color space conversion, content adaptive contrast enhancement, flip operations, and the like on the received frame, and may output the processed frame to the layer mixer processing block 304.

The layer mixing processing block 304 may perform blending and mixing of the frame with one or more other surfaces. For example, the layer mixing processing block 304 may perform alpha blending, color generation, setting of a transparency color key, blending of surfaces in arbitrary order, and blending in linear space. As an example, the display processor 106 may retrieve a frame from the memory 124 that is a frame captured by the video source 126 for processing. The layer mixing processing block 304 may receive the frame, mix the frame with one or more additional graphical surfaces or images, and output the mixed frame. For example, the layer mixing processing block 304 may layer the frame with graphical trajectory lines that indicate the vehicle's trajectory as it backs up according to the current steering angle of the vehicle. In another example, the frame may be layered with graphical user interface (GUI) menu options (such as a home icon, back icon, or menu icon), and the like. The layer mixing processing block 304 may also layer the frame with the animated graphic of the animation. The layer mixing processing block 304 may output the blended/mixed frame to the DSPP 306. In some examples of the disclosure, when processing some ROIs of a display for an ADAS system, the layer mixing processing block 304 may be expected to not alter the pixels in the ROIs.

The DSPP 306 may perform post-mixer processing functions such as conversion, correction, and adjustments on the frame received from the layer mixing processing block 304 based on particular characteristics of the display device 128. For example, the DSPP 306 may perform operations for sunlight visibility improvement, content adaptive backlight scaling, panel color correction, gamma correction, dithering, picture adjustments, and the like. After processing the input frame, the display processor 106 may output the processed frame to the display device 128 via, for example, a video controller (e.g., the video controller 112). In some examples of the disclosure, when processing some ROIs of a display for an ADAS system, the DSPP 306 may be expected to alter the pixels in the ROIs.

To ensure the integrity of the processing pipeline 310, the display processor 106 may check whether the processing pipeline 310 introduced any errors after the input frame is processed. For example, the first data integrity calculation block 308 may calculate a data integrity check value (e.g., MISR 1) of the processed input frame, and the comparator 312 may compare the data integrity check value of the processed input frame to another data integrity check value (e.g., MISR 2), which may be calculated before the input frame was processed by the processing pipeline 310. For example, the display processor 106 may calculate data integrity check values 320 (e.g., a MISR, CRC, or checksum value) associated with an animation (e.g., the animation 200) on one or more regions-of-interest (ROIs) of input frame data to be processed by the display processor 106.

In certain aspects, the data integrity check values may be calculated on a segment of the ROI or animation with a signed keyword. The segment may be selected (e.g., masked) bits within the ROI or animation. For example, a fixed segment of the content may have a signed keyword that is hidden deterministically in the frame, ROI of the frame, or animation. Steganography based checks may validate the processed frame where only a subset of bits of the rendered content having the signed keyword are checked across frames using a data integrity check value, such as CRC, MISR, checksum, or hash function.

In the example shown, the data integrity check values 320 include a first data integrity check value 322, a second data integrity check value 324, a third data integrity check value 326, and an nth data integrity check value 328. The data integrity check values 320 may include any number of data integrity check values associated with an animation. For example, there may be 2, 4, 8, or 16 data integrity check values associated with an animation.

The data integrity check values 320 may include data integrity check values for each frame of an animation or a corresponding change to or transformation of an animated graphic (e.g., the animated graphic 210) over the course of the animation. For example, the first data integrity check value 322 may correspond to the initial appearance of the animated graphic (e.g., as depicted in the frame 202 of FIG. 2); the second data integrity check value 324 may correspond to the next change in appearance to the animated graphic (e.g., as depicted in the second frame 204; the third data integrity check value 326 may correspond to another change in appearance to the animated graphic (e.g., as shown in the frame 206); and the nth data integrity check value 328 may correspond to the last change in appearance to the animated graphic (e.g., as illustrated in the frame 208).

Each of the data integrity check values 320 may have corresponding configurable parameters associated with the animated graphic of the animation. The configurable parameters may enable a vehicle manufacturer to customize the integrity check of the animated graphic to the specifications of a particular vehicle display system. For example, each of the data integrity check values 320 may correspond to at least one of a ROI of a frame (such as the input frame 316), a number of frames in the animation, or a number of frames until a next data integrity check value is to be selected for comparison. For example, the first data integrity check value 322 may correspond to a particular ROI of the input frame where the animated graphic will appear in the frame. The first data integrity check value 322 may also correspond to a certain number of frames of the animation, such as the first 15 or 30 frames of the animation. For example, the animated graphic may keep the same appearance during the course of the 15 or 30 frames of the animation. The first data integrity check value 322 may also correspond to a certain number of frames (e.g., 10 frames) to wait before moving to the next data integrity check value, such as the second data integrity check value 324.

In certain aspects, the data integrity check values 320 may include a cumulative data integrity check value associated with the animation. The cumulative data integrity check value may provide an integrity check across the entire animation or sequence of frames. For example, the nth data integrity check value 328 may be the cumulative data integrity check value, which may be calculated across all the frames of the animation.

In certain aspects, the comparator 312 may compare data check integrity values (such as MISR 1, which is calculated from the processed input frame, and MISR 2, which is calculated before processing the input frame or selected from the data integrity check values 320) and determine whether the display processor 106 introduced an error based on a difference between the data integrity check values (MISR 1 and MISR 2) being greater than a certain threshold. In aspects, the comparator 312 may generate an interrupt 314 if the comparison indicates that a first data integrity check value (e.g., MISR 1) and a second data integrity check value (e.g., MISR 2) do not match. In aspects, the comparator 312 may indicate that the first data integrity check value (e.g., MISR 1) and the second data integrity check value (e.g., MISR 2) do not match based on whether a comparison between the first data integrity check value and the second data integrity check value is outside a margin of error or above a threshold value. In other aspects, the comparator 312 may indicate that the first data integrity check value (e.g., MISR 1) and the second data integrity check value (e.g., MISR 2) do not match based on whether a difference between the first data integrity check value and the second data integrity check value is above or below a threshold value. For example, if MISR 1 and MISR 2 match (e.g., within some margin for error), the processed input frame is determined to be correct and is displayed. If MISR 1 and MISR 2 do not match (e.g., a comparison between MISR 1 and MISR 2 is outside some margin of error or a difference between MISR 1 and MISR 2 is a above a threshold value), the interrupt 314 is generated and an alert and/or recovery process may be initiated. In some examples, the compared data integrity check values may not be identical to determine that the data integrity check values match and the display processor 10 is functioning normally.

In other aspects, the comparator 312 may compare the data check integrity values and determine whether or not they are different. The comparator 312 may be generate an interrupt if a threshold number of contiguous comparisons (e.g., comparisons of data integrity check values for contiguous frames) indicate an error. Accordingly, in this example, the threshold may be the number of contiguous errors detected before comparator 312 generates an interrupt indicating an error.

To ensure the integrity of the video data after being processed by display processor 106, the display processor 106 may generate data integrity check values 320 (e.g., a CRC, MISR, checksum, etc.) associated with an animation, for example, based on a software model of the processing pipeline 310 to be performed by the display processor 106. For example, the display processor 106 may process one or more regions-of-interest (ROI) of the input frame(s) 316 (e.g., safety critical image data as indicated by a ROI configuration) with a software model, which may emulate the operations of the processing pipeline 310. After processing the ROIs of the input frames through the software model, the display processor 106 may calculate the data integrity check values 320 for the resultant frames. The data integrity check values 320 may be stored in the memory 124 and associated with an animation in a particular ROI of sequence of input frames.

In certain aspects, the display processor 106 may check the integrity of the input frame before any processing. For example, the second data integrity calculation block 318 may calculate a data integrity check value (e.g., MISR 3) of the input frame before the frame is processed by the processing pipeline. The comparator 312 may compare the data integrity check value output by the second data integrity calculation block 318 to one of the data integrity check values 320 associated with an animation. For example, the data integrity check values 320 associated with the animation may be calculated based on the input frames before any processing. The display processor 106 may calculate the data integrity check values 320 of the animation for a ROI of input frames before any processing. The data integrity check values 320 may be stored in the memory 124 and associated with an animation in a particular ROI of the input frames.

Aspects of the present disclosure are not limited to ensuring the integrity of content only at the end of the processing pipeline 310. For example, the post-processing data integrity check values may be calculated and compared at different points of the processing pipeline 310, for example, after processing by the SSPP 302 or after the layer mixing block 304. In addition, the data integrity check values 320 associated with the animation may be calculated to emulate the processed input frame at respective points of the processing pipeline 310.

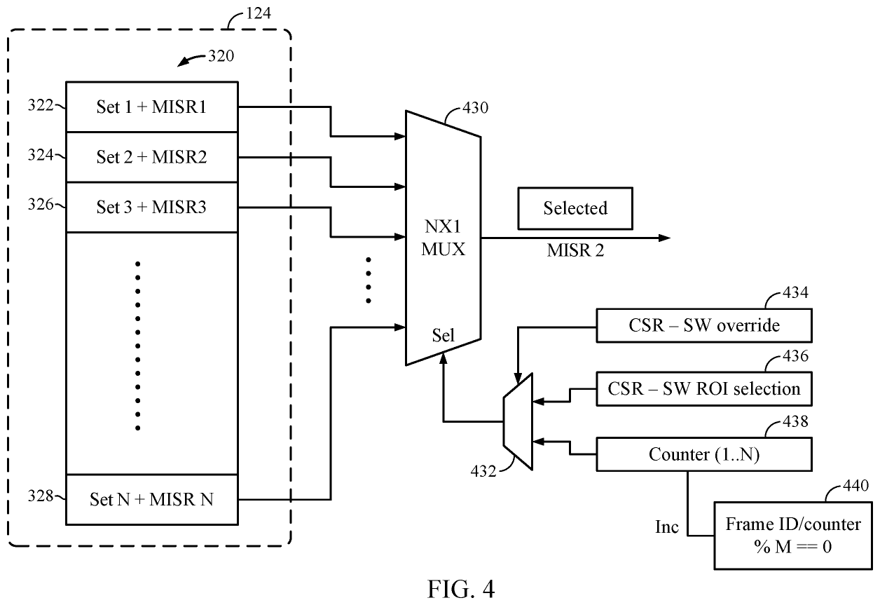

FIG. 4 is a block diagram illustrating example hardware aspects of the display system 300, in accordance with certain aspects of the present disclosure. As shown, a data integrity check value (e.g., data integrity check value 322, 324, 326, or 328) may be selected among the set of data integrity check values 320 stored on the memory 124 to be used by the comparator 312 as depicted in in FIG. 3. A first multiplexer 430 may be coupled to the memory 124 and select one of the data integrity check values 320 from the memory 124 according to the configurable parameters associated with the animated graphic of the animation as described herein. The data integrity check values 320 may be calculated on a segment of the animation with a signed keyword. Steganography based checks may validate the processed frame in relation to the data integrity check values 320. A second multiplexer 432 may be coupled to a selection input of the first multiplexer 430 and output control signals for selecting the data integrity check value 322, 324, 326, or 328.

The second multiplexer 432 may be coupled to a first configuration and status register (CSR) 434, a second CSR 436, and a counter 438 and generate the control signals output to the selection input of the first multiplexer 430. The first CSR 434 may indicate whether to enable a software override of the integrity checks of the display system. In aspects, the first CSR 434 may feed a particular data integrity check value to the first multiplexer 430 or directly to comparator 312. The software override may enable certain display systems without the hardware described herein with respect to FIG. 4 to perform the integrity checks on an animation. In other aspects, if the first CSR 434 is enabled, the second multiplexer 432 may select the data integrity check value based on an index value associated with the data integrity check values 320 without considering a frame count or a particular ROI. In other aspects, the first CSR 434 may trigger the selection of the next data integrity check value in the set of data integrity check values 320.

The second CSR 436 may indicate which ROI of the input frame is being checked by the display processor 106. The second CSR 436 may provide the first multiplexer 430 with the information to select the data integrity check values 320 associated with the particular animation in the ROI as further described herein with respect to FIG. 5.

The counter 438 may indicate when to switch to the next data integrity check value based on the frame count. For example, a frame count register 440 may increment the counter 438 after a certain number of frames, such as every M frames, a certain number of frames corresponding to the data integrity check value (e.g., the number of frames where the animated graphic keeps the same appearance in the ROI), or a certain number of frames until a next data integrity check value is to be selected for comparison.

In certain aspects, the operation of selecting the data integrity check values 320 may be implemented as software. For example, some display systems may not have the hardware described herein with respect to FIG. 4, and similar functionality may be implemented by performing the operation of selecting the data integrity check values 320 as a software diagnostic for safety critical applications. For instance, a data integrity check value may be associated with each frame of an animation. The display processor 106 may reconfigure the data integrity check value (MISR 2) for the ROI on a per frame basis, and the comparator 312 may compare the data integrity check values (MISR 1 and MISR 2) based on the reconfigured value (MISR 2). As an example, suppose the animation includes 10 frames, the display processor 106 may pre-compute the data integrity check values for all of the 10 frames of the animation and re-configures the comparator 312 on a per frame basis to verify the processed input frame for each of the frames associated with the animation.

FIG. 5 is a diagram illustrating an example frame 500 divided into ROIs with animated graphics, in accordance with certain aspects of the present disclosure. The frame 500 may be a frame of a digital instrument cluster, for example. As shown, the frame 500 may include ROIs 502, 504, 506, 508. The first ROI 502 may include animated graphics 510, 512, and 514, which may be animated warnings or animated tell-tales. The second ROI 504 may include an animated graphic 516, which may be a digital speedometer, for example. The third ROI 506 may include an animated graphic 518, such as an animated warning. As an example, the third ROI 506 may display various dynamic content, such as a backup-camera, turn-by-turn navigation, fuel economy, driving range, music or stereo information, call history information, or a compass. In certain situations, the display processor 106 may mix the animated graphic 518 over the dynamic image data in the third ROI 506. The fourth ROI 508 may include an animated graphic 520, which may be a digital tachometer or other gauge (e.g., a coolant temperature gauge, a voltage gauge, an oil pressure gauge, a battery life meter, etc.), for example.

The display processor 106 may compute the data integrity check values 320 associated with each of the animated graphics 510, 512, 514, 516, 518, 520 or a subset of the animated graphics 510, 512, 514, 516, 518, 520. In some examples, the display processor 106 may perform the content integrity check for each of the ROIs 502, 504, 506, 508. That is, for a given input frame, the display processor 106 may rotate through each of the ROIs 502, 504, 506, 508 and perform a content integrity check on the image data in a particular ROI. In certain aspects, the display processor 106 may perform the content integrity check on the basis of ROI groups or a subset of the ROIs. For example, one or more ROIs may be grouped together, and for a given input frame, the display processor 106 may perform the content integrity check on certain group(s) of the ROI(s). In aspects, the display processor 106 may rotate through the ROIs or group of ROIs on a per frame basis or per N frames.

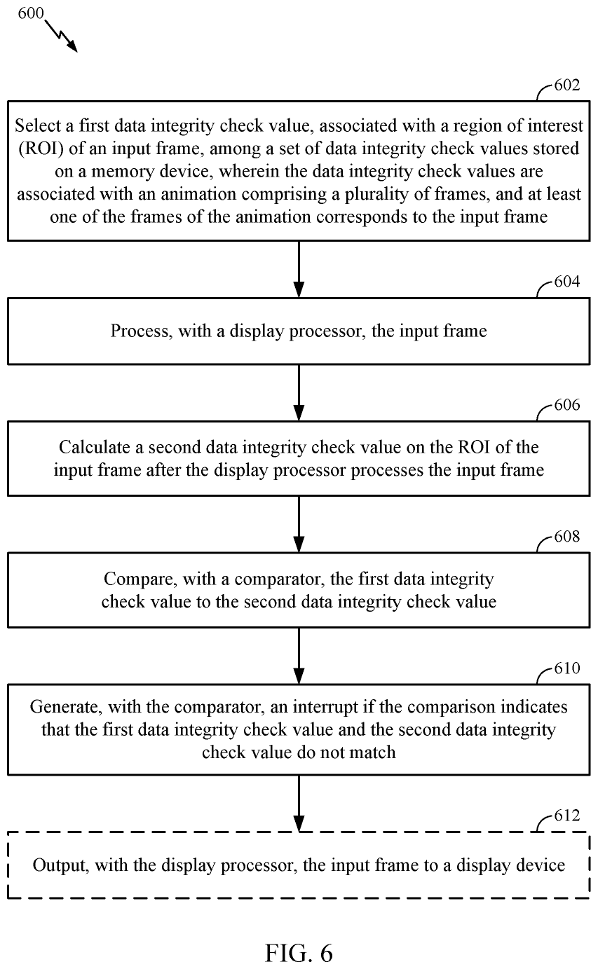

FIG. 6 is a flow diagram of example operations 600 for testing a display system, in accordance with certain aspects of the present disclosure. The operations 600 may be performed by a display system (e.g., the display system 300), one or more processors (e.g., the processor 102, 104, 106, 108, and/or 116), or a SoC (e.g., the SoC 100), for example.

The operations 600 begin, at block 602, where the display system selects a first data integrity check value (e.g., first data integrity check value 322 or MISR 2), associated with a ROI (e.g., the first ROI 502) of an input frame (e.g., the input frame 316), among a set of data integrity check values (e.g., the data integrity check values 320) stored on a memory device (e.g., the memory 124). The data integrity check values are associated with an animation (e.g., the animation 200) comprising a plurality of frames (e.g., frames 202, 204, 206, 208), and at least one of the frames of the animation corresponds to the input frame. At block 604, a display processor (e.g., the display processor 106) of the display system may process the input frame. For example, the display processor may process the input frame through a processing pipeline, such as the processing pipeline 310. At block 606, the display processor may calculate a second data integrity check value (e.g., MISR 1) on the ROI of the input frame after the display processor processes the input frame. At block 608, a comparator (e.g., the comparator 312) may compare the first data integrity check value to the second data integrity check value. At block 610, the comparator may generate an interrupt (e.g., the interrupt 314) if the comparison at block 608 indicates that the first data integrity check value and the second data integrity check value do not match. At block 612, the display processor may output the input frame to a display device (e.g., the display device 128).

In certain aspects, the display processor may calculate each of the data integrity check values in the set and store the data integrity check values in the memory device. For example, the display processor may calculate the set of the data integrity check values, including the first data integrity check value, on the ROI of the input frame and store the data integrity check values in the memory device. The display processor may fetch the first data integrity check value from the memory device upon determining that the first data integrity check value corresponds with the ROI of the input frame.

In certain aspects, each of the data integrity check values in the set may correspond to various configurable parameters associated with the animation as described herein with respect to FIG. 3. For instance, each of the data integrity check values may correspond to at least one of a ROI of a frame, a number of frames in the animation, or a number of frames until a next data integrity check value is to be selected.

In certain aspects, the display processor may check the integrity of the appearance of multiple animations in the same ROI. That is, the operations 600, described herein, may support multiple animations in the same ROI (such as the first ROI 502 illustrated in FIG. 5). For example, the display system may have multiple sets of data integrity check values, and some of sets of data integrity check values may be associated with different animations in the same ROI. The display processor may select the appropriate animation(s) for the ROI being checked and generated in the input frame by the display processor. In aspects, the display processor may identify that the input frame is associated with the animation among a plurality of animations corresponding to the ROI and select the corresponding set of data integrity check values associated with the animation to perform the data integrity check operations described herein.

In certain aspects, the operations 600 may include the display processor performing a data integrity check on a plurality of input frames based on a cumulative data integrity check associated with the animation. For example, the display system may process all or some of the input frames corresponding to the ROI with the animation at the processing pipeline 310, generate a cumulative data integrity check value (e.g., MISR 1), and compare the cumulative data integrity check values to determine whether an error was introduced.

In certain aspects, the operations 600 may provide a software override for selecting the data integrity check values. Some display systems may not have the hardware described herein with respect to FIG. 4, and similar functionality may be implemented by performing the operation of selecting the first data integrity check value as software. For instance, the display processor may pre-calculate the data integrity check values for the animation in the ROI and reconfigure the comparator to apply the appropriate data integrity check value for the ROI of the input frame on a per frame basis as described herein with respect to FIG. 4.

In the operations 600, the display processor may also select the next data check value among the set of data integrity check values. For instance, the display processor may select a third data integrity check value (e.g., second data integrity check value 324), associated with the ROI of a next input frame, among the set of data integrity check values associated with the animation. The display processor may process the next input frame and calculate a fourth data integrity check value on the ROI after processing the next input frame. The comparator may compare the third data integrity check value to the fourth data integrity check value and the interrupt if the comparison indicates that the third data integrity check value and the fourth data integrity check value do not match. The display processor may output the next input frame to the display device.

In certain aspects, the display system may rotate through the ROIs on a per frame basis or per a certain number (N) of frames. For instance, the display system may perform a data integrity check on the input frame in another ROI, wherein the data integrity check is associated with another animation comprising a plurality of frames. As another example, the display system may select, for a plurality of input frames, a first ROI among a plurality of ROIs and perform a first set of data integrity checks associated with one or more first animations on the plurality of frames in the first ROI. The display system may then select, for the plurality of input frames, a next ROI among the plurality of ROIs and perform a second set of data integrity checks associated with one or more second animations on the plurality of frames in the first ROI.

The input frame may be produced by one or more cameras or sensors (e.g., the video source) of a vehicle. The input frame may be displayed on an instrument cluster of a vehicle, a HUD of the vehicle, center-console screen of the vehicle, etc., such as the display device 128.

The display system and/or SoC may perform various actions in response to the interrupt. For instance, the SoC may generate one or more of an auditory, visual, or haptic warning in response to generating the interrupt. In other aspects, the SoC may initiate a recovery process in response to the generating the interrupt.

Although the teachings of the present disclosure are illustrated in terms of content integrity of animations for a display system of a SoC, the teachings are applicable in other areas such as integrity checks on any type of content, such as any processed sequence of digital content including digital signals, audio data, image data, or a rendered surface that is blended and written to memory/disk for further processing. The teachings disclosed should not be construed to be limited to integrity checks for a display system of a SoC or the illustrated embodiments. The illustrated embodiments are merely vehicles to describe and illustrate examples of the inventive teachings disclosed herein.

The term “multicore processor” is used herein to refer to a single integrated circuit (IC) chip or chip package that contains two or more independent processing units or cores (e.g., CPU cores, etc.) configured to read and execute program instructions. The term “multiprocessor” is used herein to refer to a system or device that includes two or more processing units configured to read and execute program instructions.

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.), any or all of which may be included in one or more cores.

A number of different types of memories and memory technologies are available or contemplated in the future, all of which are suitable for use with the various aspects. Such memory technologies/types include phase change memory (PRAM), dynamic random-access memory (DRAM), static random-access memory (SRAM), non-volatile random-access memory (NVRAM), pseudostatic random-access memory (PSRAM), double data rate synchronous dynamic random-access memory (DDR SDRAM), and other random-access memory (RAM) and read-only memory (ROM) technologies known in the art. A DDR SDRAM memory may be a DDR type 1 SDRAM memory, DDR type 2 SDRAM memory, DDR type 3 SDRAM memory, or a DDR type 4 SDRAM memory. Each of the above-mentioned memory technologies include, for example, elements suitable for storing instructions, programs, control signals, and/or data for use in or by a computer or other digital electronic device. Any references to terminology and/or technical details related to an individual type of memory, interface, standard or memory technology are for illustrative purposes only, and not intended to limit the scope of the claims to a particular memory system or technology unless specifically recited in the claim language.

The various aspects may be implemented in a wide variety of computing systems, including single processor systems, multiprocessor systems, multicore processor systems, systems-on-chip (SoC), or any combination thereof.

The various embodiments are described in detail with reference to the accompanying drawings. Wherever possible, the same reference numbers are be used throughout the drawings to refer to the same or like parts. References made to particular examples and implementations are for illustrative purposes, and are not intended to limit the scope of the invention or the claims.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method of testing a display system, comprising:
selecting a first data integrity check value, associated with a region of interest (ROI) of an input frame, among a set of data integrity check values stored on a memory device, wherein the data integrity check values are associated with an animation comprising a plurality of frames, and at least one of the frames of the animation corresponds to the input frame;
processing, with a display processor, the input frame;
calculating a second data integrity check value on the ROI of the input frame after the display processor processes the input frame;
comparing, with a comparator, the first data integrity check value to the second data integrity check value; and
generating, with the comparator, an interrupt if the comparison indicates that the first data integrity check value and the second data integrity check value do not match.

2. The method of claim 1, further comprising:
calculating the first data integrity check value on the ROI of the input frame; and
storing the first data integrity check value in the memory device.

3. The method of claim 1, wherein each of the data integrity check values corresponds to at least one of a ROI of a frame, a number of frames in the animation, or a number of frames until a next data integrity check value is to be selected.

4. The method of claim 1, further comprising identifying that the input frame is associated with the animation among a plurality of animations corresponding to the ROI.

5. The method of claim 1, further comprising performing a data integrity check on a plurality of input frames based on a cumulative data integrity check associated with the animation.

6. The method of claim 1, further comprising:
calculating the data integrity check values for the animation in the ROI; and
reconfiguring the comparator to apply the first data integrity check value for the ROI of the input frame.

7. The method of claim 1, further comprising:
selecting a third data integrity check value, associated with the ROI of a next input frame, among the set of data integrity check values associated with the animation;
processing the next input frame;
calculating a fourth data integrity check value on the ROI after processing the next input frame;
comparing the third data integrity check value to the fourth data integrity check value;
generating the interrupt if the comparison indicates that the third data integrity check value and the fourth data integrity check value do not match.

8. The method of claim 1, further comprising performing a data integrity check on the input frame in another ROI, wherein the data integrity check is associated with another animation comprising a plurality of frames.

9. The method of claim 1, further comprising:
selecting, for a plurality of input frames, a first ROI among a plurality of ROIs;
performing a first set of data integrity checks associated with one or more first animations on the plurality of frames in the first ROI;
selecting, for the plurality of input frames, a next ROI among the plurality of ROIs; and
performing a second set of data integrity checks associated with one or more second animations on the plurality of frames in the first ROI.

10. The method of claim 1, wherein the input frame is a frame produced by one or more cameras of a vehicle.

11. The method of claim 1, further comprising outputting, with the display processor, the input frame to a display device, wherein the input frame is a frame to be displayed on the display device including an instrument cluster of a vehicle.

12. The method of claim 1, wherein the animation is an animation of one or more tell-tale icons of an instrument cluster.

13. The method of claim 1, further comprising generating one or more of an auditory, visual, or haptic warning in response to generating the interrupt.

14. The method of claim 1, further comprising initiating a recovery process in response to generating the interrupt.

15. An apparatus for testing a display system, comprising:
a memory device having a set of data integrity check values stored thereon;
a processor configured to:
process an input frame,
select a first data integrity check value, associated with a region of interest (ROI) of the input frame, among the set of data integrity check values stored on the memory device, wherein the data integrity check values are associated with an animation comprising a plurality of frames, and at least one of the frames of the animation corresponds to the input frame, and
calculate a second data integrity check value on the ROI of the input frame after the display processor processes the input frame; and
a comparator configured to:
compare the first data integrity check value to the second data integrity check value, and
generate an interrupt if the comparison indicates that the first data integrity check value and the second data integrity check value do not match.

16. The apparatus of claim 15, wherein each of the data integrity check values corresponds to at least one of a ROI of a frame, a number of frames in the animation, or a number of frames until a next data integrity check value is to be selected.

17. The apparatus of claim 15, wherein the processor is further configured to identify that the input frame is associated with the animation among a plurality of animations corresponding to the ROI.

18. The apparatus of claim 15, wherein the processor is further configured to performing a data integrity check on a plurality of input frames based on a cumulative data integrity check associated with the animation.

19. The apparatus of claim 15, wherein the processor is further configured to output the input frame to a display device and generate the input frame that is an image to be displayed on the display device including an instrument cluster of a vehicle.

20. The apparatus of claim 15, wherein the processor is further configured to obtain the input frame from a camera of a vehicle.
